(19) United States
(12) Patent Application Publication
(10) Pub. No.: US 2024/0079615 A1
(43) Pub. Date: Mar. 7, 2024

(54) RAPID SHUTDOWN SYSTEM OF ENERGY STORAGE DEVICE

(71) Applicant: LITE-ON TECHNOLOGY CORPORATION, Taipei (TW)

(72) Inventor: Jun Han CHEN, Taipei (TW)

(21) Appl. No.: 17/987,488

(22) Filed: Nov. 15, 2022

(30) Foreign Application Priority Data
Sep. 2, 2022 (CN) 202211074789.6

(51) Int. Cl. H01M 8/04228; H01M 8/04303

(52) U.S. Cl. CPC H01M 8/04228; H01M 8/04303

(57) ABSTRACT

A rapid shutdown system of an energy storage device includes a battery module, a boost circuit, a second switch element and an output circuit. The battery module has a first end and a second end. The boost circuit includes a first switch element and an active or passive switch element, wherein the first switch element is controlled by a first control signal to be conducted or non-conducted between the first end and the second end. The second switch element has a third end and a fourth end, wherein the third end is connected to the active or passive switch element. The output circuit has a fifth end and a sixth end, wherein an output voltage exists between the fifth end and the sixth end. The second switch element is controlled by a second control signal to be conducted or non-conducted between the boost circuit and the output circuit.

This application claims the benefit of People's Republic of China application Serial No. 202211074789.6, filed Sep. 2, 2022, the subject matter of which is incorporated herein by reference.

### BACKGROUND OF THE INVENTION

### Field of the Invention

The invention relates in general to a shutdown system, and more particularly to a rapid shutdown system of an energy storage device.

### Description of the Related Art

Energy storage device can be realized by such as a lithium battery module, a solar cell module, or a fuel cell module. To enhance the safety of an energy storage device, the energy storage device can be rapidly shut down when safety failure occurs, and can resume energy supply once safety failure disappears. Generally speaking, a breaker needs to be installed on each photovoltaic module of the solar photovoltaic system. Once safety failure disappears, the breaker is turned on again, so that the photovoltaic module connected to the breaker can output an electric power. That is, to meet the current regulation requirements, the solar photovoltaic system needs to be provided with a rapid shutdown function implemented by a system controller. Such additional installation, which can be realized by such as a DC breaker or a control logic relay, increases the configuration cost.

### SUMMARY OF THE INVENTION

The invention is directed to a rapid shutdown system of an energy storage device capable of integrating a rapid shutdown element into a boost circuit to reduce the configuration cost.

According to one embodiment of the present invention, a rapid shutdown system of an energy storage device is provided. The rapid shutdown system of an energy storage device includes a battery module, a boost circuit, a second switch element and an output circuit. The battery module has a first end and a second end. The boost circuit includes a first switch element and an active or passive switch element, wherein the first switch element, having one end connected to the active or passive switch element and the other end connected to the second end, is controlled by a first control signal to be conducted or non-conducted between the first end and the second end. The second switch element has a third end and a fourth end, wherein the third end is connected to the active or passive switch element. The output circuit has a fifth end and a sixth end, wherein an output voltage exists between the fifth end and the sixth end; the fifth end is connected to the fourth end; the sixth end is connected to the second end. The second switch element is controlled by a second control signal to be conducted or non-conducted between the boost circuit and the output circuit.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A is a schematic diagram of a rapid shutdown system of an energy storage device according to an embodiment of the invention;

FIGS. 1B and 1C respectively are schematic diagrams of the first switch element being conducted and being non-conducted; and

FIG. 2 is a schematic diagram of a rapid shutdown system of an energy storage device according to another embodiment of the invention;

FIG. 3 is a waveform diagram of first switch element, a diode or an active switch element, a second switch element and an inductor current;

FIGS. 4A and 5 respectively are schematic diagrams of a rapid shutdown system of an energy storage device according to another two embodiments of the invention; and

FIGS. 4B and 4C respectively are schematic diagrams of the first switch element being conducted and being non-conducted.

### DETAILED DESCRIPTION OF THE INVENTION

Technical solutions for the embodiments of the present application are clearly and thoroughly disclosed with accompanying drawings. Obviously, the embodiments disclosed below are only some rather than all of the embodiments of the present application. All embodiments obtained by anyone ordinarily skilled in the technology field of the present application according to the disclosed embodiments of the present application are within the scope of protection of the present invention if the obtained embodiments lack innovative labor. Similar/identical designations are used to indicate similar/identical elements.

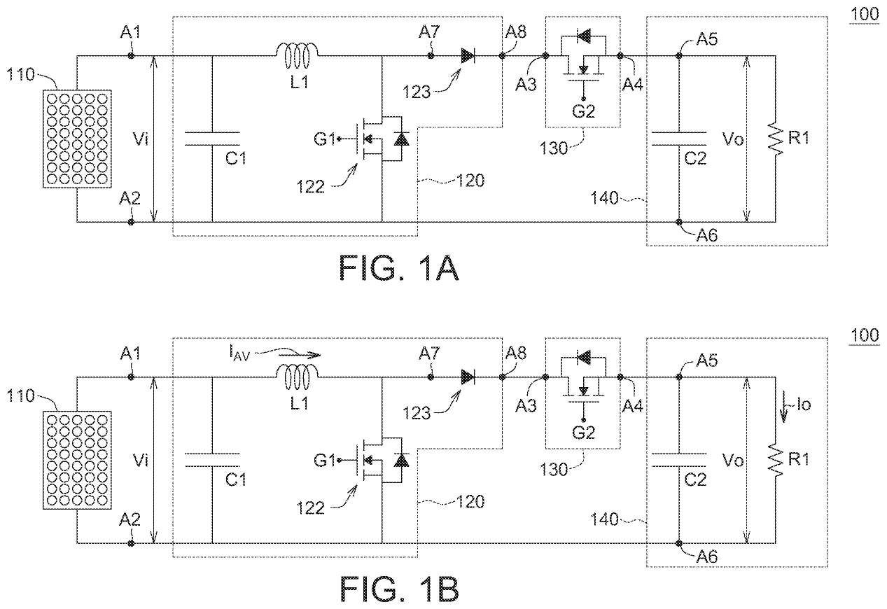

Referring to FIG. 1A, a schematic diagram of a rapid shutdown system 100 of an energy storage device according to an embodiment of the invention is shown. The rapid shutdown system 100 of an energy storage device includes a battery module 110, a boost circuit 120, a second switch element 130 and an output circuit 140. The battery module 110 has a first end A1 and a second end A2, wherein a DC voltage Vi exists between the first end A1 and the second end A2. The boost circuit 120 includes a first switch element 122 and a passive switch element (such as a diode 123). The first switch element 122 has one end connected to the passive switch element (such as the anode A7 of the diode 123) and the other end connected to the second end A2. The first switch element 122 is controlled by a first control signal to be conducted or non-conducted between the first end A1 and the second end A2. The second switch element 130 has a third end A3 and a fourth end A4, wherein the third end A3 is connected to the passive switch element (such as the cathode A8 of the diode 123). The output circuit 140 has a fifth end A5 and a sixth end A6, wherein an output voltage Vo exists between the fifth end A5 and the sixth end A6; the fifth end A5 is connected to the fourth end A4; the sixth end A6 is connected to the second end A2. The second switch element 130 is controlled by a second control signal to be conducted or non-conducted between the boost circuit 120 and the output circuit 140.

The battery module 110 can be a solar photovoltaic module or an energy storage module of other type. The photovoltaic module can be formed of a plurality of photoelectric elements arranged in series or parallel for outputting a direct current. A converter converts the direct current into an alternating current, which is then outputted to a power grid. Take the solar photovoltaic module for instance. The solar photovoltaic module uses the boost circuit 120 to convert a low voltage into a high voltage, which is then converted into an AC voltage and outputted by a DC/AC converter (diagram is omitted). Since the photoelectric elements connected in series or parallel have a high voltage, the battery module 110 needs to have an additionally installed rapid shutdown system 100 to increase the safety of the energy storage device. When safety failure occurs, the energy storage device can be rapidly shut down; once safety failure disappears, the energy storage device can resume power supply.

In the present embodiment, the rapid shutdown system 100 is integrated into the boost circuit 120 without an additional installation of a DC breaker or a control logic relay, so that the configuration cost can be effectively reduced.

As indicated in FIG. 1A, the boost circuit 120 further includes a boost capacitor C1 and a boost inductor L1 in addition to the first switch element 122 and the diode 123 disclosed above. Besides, the output circuit 140 further includes an output capacitor C2 and an output resistor R1. The output capacitor C2 and the output resistor R1 are connected in parallel between the fifth end A5 and the sixth end A6 of the output circuit 140.

As indicated in FIG. 1A, the two ends of the boost capacitor C1 respectively are connected to the first end A1 and the second end A2 of the battery module 110; the two ends of the boost inductor L1 respectively are connected to the first end A1 and the anode A7 of the diode 123. The first switch element 122 can be realized by a metal-oxide-semiconductor field-effect transistor (MOSFET) or an insulated gate bipolar transistor (IGBT), wherein the insulated gate bipolar transistor (IGBT) is a composite semiconductor power element formed by a bipolar junction transistor (BJT) and an MOSFET; the control end (gate G1) of the first switch element 122 is connected to a controller (diagram is omitted; such as micro-controller MCU). The controller can generate a first control signal (such as a PWM signal) for enabling the first switch element 122 to be conducted or non-conducted. Through the conduction or non-conduction of the first switch element 122, the DC voltage Vi generated by the battery module 110 is boosted to an output voltage Vo.

Besides, the diode 123 is a one-way conduction element, which merely allows the current to flow from the anode A7 to the cathode A8 of the diode 123, but does not allow the current to flow from the cathode A8 to the anode A7 of the diode 123, so that the reverse current flowing from the output circuit 140 to the boost circuit 120 can be cut off. When the first switch element 122 is conducted or non-conducted, the diode 123 will correspondingly be non-conducted or conducted.

Refer to FIG. 1B. When the first switch element 122 is conducted, the voltage at the anode A7 of the diode 123 is lower than the output voltage Vo at the output circuit 140; meanwhile, the diode 123 is reverse biased to be non-conducted, the current I_{AV} flows through the boost inductor L1 along a clockwise direction, and the boost inductor L1 starts to generate a magnetic field to store energy. Hence, the current I_{AV} of the boost inductor L1 is increased, and the boost capacitor C1 is charged. The output capacitor C2 of the output circuit 140 releases energy to the output resistor R1. The output resistor R1 has an output voltage Vo, and the output resistor R1 has a current Io.

Refer to FIG. 1C. When the first switch element 122 is non-conducted, the voltage at the anode A7 of the diode 123 is higher than the output voltage Vo at the output end; meanwhile, the diode 123 is forward biased to be conducted, the current I_{AV} of the boost inductor L1 flows to the output circuit 140, and the boost capacitor C1 is discharged. The current I_{AV} continues to flow through the boost inductor L1 along a clockwise direction, but the current I_{AV} is decreased and charges the output capacitor C2 via the diode 123. As the electrical energy of the battery module 110 is aggregated with the electrical energy of the boost capacitor C1 and the electrical energy of the boost inductor L1, the electrical energy of the output capacitor C2 is increased. Thus, the output capacitor C2 can store more electrical energy and boost the output voltage Vo, and the current Io of the output resistor R1 is correspondingly increased.

The above disclosure shows that through the conduction or non-conduction of the first switch element 122, the boost circuit 120 can boost the DC voltage Vi generated by the battery module 110 to the output voltage Vo, which is then outputted by the output circuit 140.

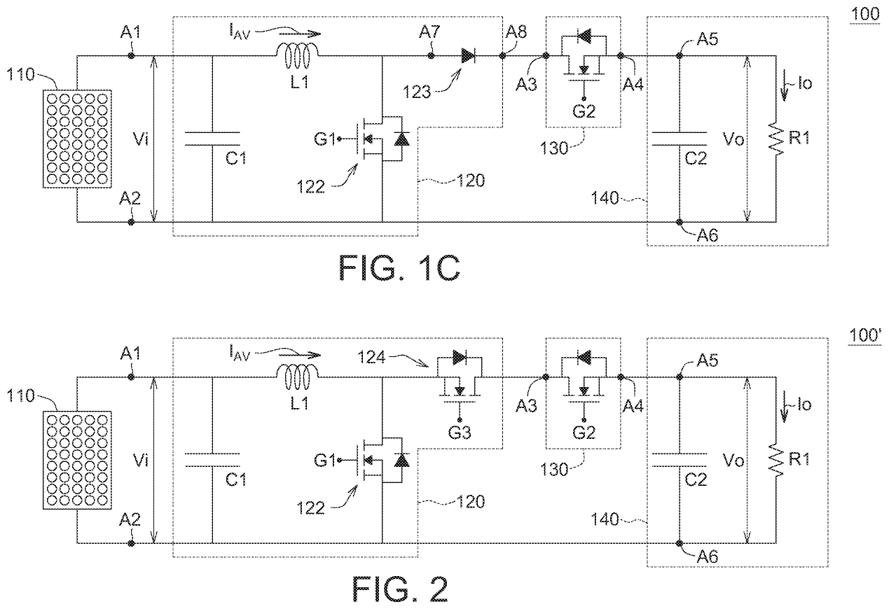

Referring to FIG. 2, a schematic diagram of a rapid shutdown system 100′ of an energy storage device according to another embodiment of the invention is shown. The present embodiment is different the above embodiments in that the diode 123 is replaced with an active switch element 124. The active switch element 124 can be realized by such as a metal-oxide-semiconductor field-effect transistor (MOSFET) or an insulated gate bipolar transistor (IGBT); the control end (gate G3) of the active switch element 124 is connected to a controller (such as a micro-controller MCU; diagram is omitted), which can generate a control signal (such as PWM signal) for enabling the active switch element 124 to be conducted or non-conducted.

When the first switch element 122 is conducted, the active switch element 124 is controlled to be non-conducted just like the diode 123 is reverse biased to be non-conducted. Meanwhile, the output capacitor C2 of the output circuit 140 releases energy to the output resistor R1, which then has an output voltage Vo and a current Io. When the first switch element 122 is non-conducted, the active switch element 124 is controlled to be conducted just like the diode 123 is forward biased to be conducted. Meanwhile, the output capacitor C2 can store more electrical energy and boost the output voltage Vo, and the current Io of the output resistor R1 is correspondingly increased.

Refer to FIGS. 1A and 2. The third end A3 of the second switch element 130 is connected to the cathode A8 of the diode 123 (referring to FIG. 1A) or is connected to one end of the active switch element 124 (referring to FIG. 2); the fourth end A4 is connected to the fifth end A5 of the output circuit 140. The second switch element 130 can be realized by such as a metal-oxide-semiconductor field-effect transistor (MOSFET) or an insulated gate bipolar transistor (IGBT); the control end (gate G2) of the second switch element 130 is connected to a controller (such as a micro-controller MCU; diagram is omitted), which can generate a second control signal (such as PWM signal) for enabling the second switch element 130 to be conducted or non-conducted. Through the conduction or non-conduction of the second switch element 130, the rapid shutdown system 100 can be started up or shut down.

Again, refer to FIG. 1A. The second switch element 130 and the diode 123 can form a two-way cutoff switch assembly; or, the second switch element 130 and the diode 123 can form an insulated gate bipolar transistor (IGBT). Again, refer to FIG. 2. The second switch element 130 and the active switch element 124 can form a source to source butting MOSFET switch assembly. That is, the second switch element 130, used as a rapid shutdown element, can be integrated with the boost circuit 120 to reduce the configuration cost.

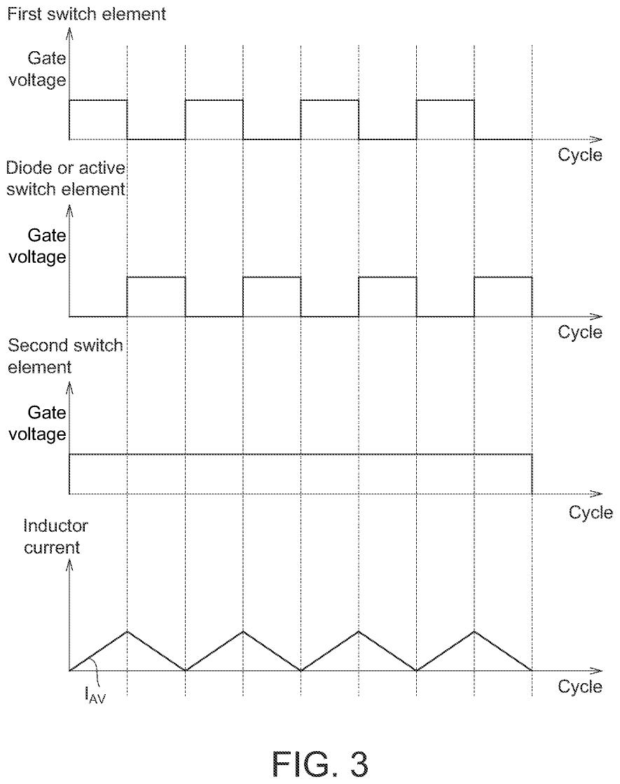

Referring to FIG. 3, waveform diagrams of a first switch element 122, a diode 123, a second switch element 130 and an inductor current I_{AV} are shown. When the first switch element 122 is conducted, the diode 123 is reverse biased (non-conducted); when the first switch element 122 is non-conducted, the diode 123 is forward biased (conducted). Therefore, within the same cycle, the first switch element 122 and the diode 123 have opposite waveforms. Besides, the waveform of the inductor current I_{AV} relatively increases or decreases as the first switch element 122 is conducted or non-conducted. Furthermore, when the second switch element 130 is conducted, the rapid shutdown system 100 is not started up, therefore the waveform of the inductor current IA/is not affected. When the second switch element 130 is non-conducted, the rapid shutdown system 100 is started up, and the inductor current I_{AV} between the boost circuit 120 and the output circuit 140 is blocked and therefore cannot be outputted.

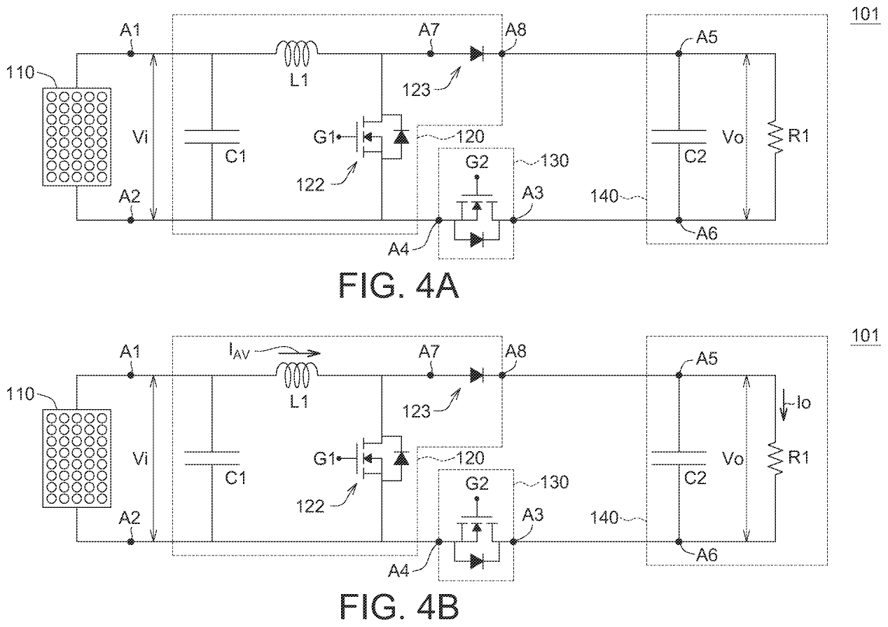

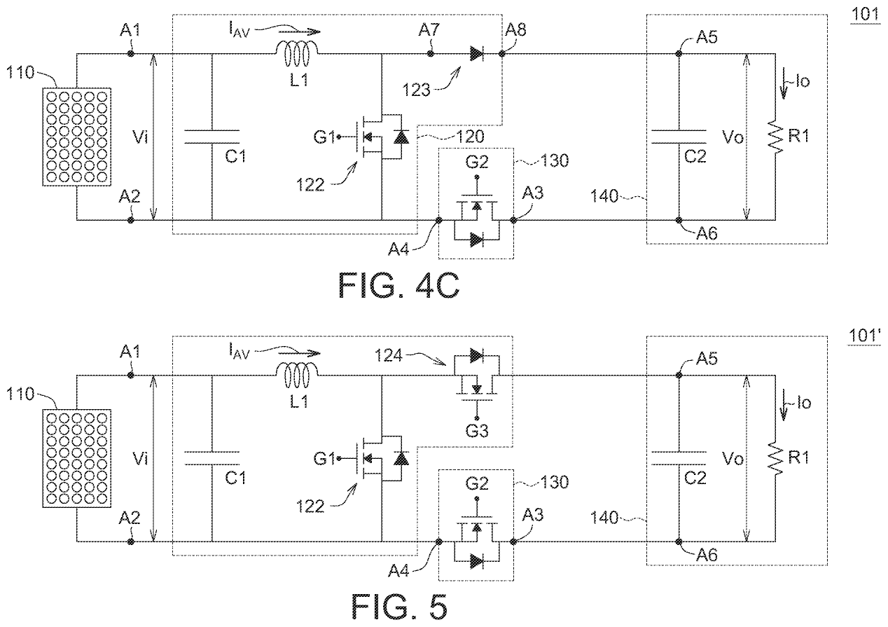

Referring to FIGS. 4 and 5, schematic diagrams of rapid shutdown system 101 and 101′ of an energy storage device according to another two embodiments of the invention are respectively shown.

Each of the rapid shutdown systems 101 and 101′ of an energy storage device includes a battery module 110, a boost circuit 120, a second switch element 130 and an output circuit 140. The battery module 110 has a first end A1 and a second end A2, wherein a DC voltage Vi exists between the first end A1 and the second end A2. The boost circuit 120 includes a first switch element 122 and an active or passive switch element (123 or 124). The first switch element 122 has one end connected to the active or passive switch element (123 or 124) and the other end connected to the second end A2. The first switch element 122 is controlled by a first control signal to be conducted or non-conducted between the first end A1 and the second end A2. The second switch element 130 has a third end A3 and a fourth end A4, wherein the fourth end A4 is connected to the second end A2. The output circuit 140 has a fifth end A5 and a sixth end A6, wherein an output voltage Vo exists between the fifth end A5 and the sixth end A6; the fifth end A5 is connected to active or passive switch element (123 or 124); the sixth end A6 is connected to the third end A3 of the second switch element 130. The second switch element 130 is controlled by a second control signal to be conducted or non-conducted between the boost circuit 120 and the output circuit 140.

The arrangements of FIGS. 4A and 5 are basically identical to the arrangement of FIGS. 1A and 2 except for the arrangement of the second switch element 130, and the similarities are not repeated here. Refer to FIG. 4A. The second switch element 130 has a third end A3 and a fourth end A4. The third end A3 is connected to the sixth end A6 of the output circuit 140; the fourth end A4 is connected to the second end A2 of the battery module 110; the second switch element 130 and the diode 123 respectively are connected to the two ends of the output capacitor C2. The second switch element 130 and the diode 123 form a two-way cutoff switch assembly; or, the second switch element 130 and the diode 123 form an insulated gate bipolar transistor (IGBT).

Refer to FIG. 4B. When the first switch element 122 is conducted, diode 123 is reverse biased to be non-conducted. Refer to FIG. 4C. When the first switch element 122 is non-conducted, the diode 123 is forward biased to be conducted. The control method is the same as that of FIG. 1B and FIG. 1C, and the similarities are not repeated here.

Refer to FIG. 5. The second switch element 130 and active switch element 124 respectively are connected to the two ends of the output capacitor C2. The second switch element 130 and the active switch element 124 form a two-way cutoff switch assembly.

Based on the above disclosure, the present invention provides a rapid shutdown method used in each of the said rapid shutdown systems 100, 100′, 101, and 101′ of an energy storage device. In a normal state, a first control signal is inputted to control (such as the gate voltage signal) the first switch element 122 to be conducted or non-conducted, wherein when the first switch element 122 is conducted, the active or passive switch elements 123 and 124 are non-conducted; when the first switch element 122 is non-conducted, the active or passive switch elements 123 and 124 are conducted. When the system determines that safety failure occurs to the battery module 110, a second control signal (such as a reduced gate voltage signal) is inputted to control the second switch element 130, so that the second switch element 130 is non-conducted between the boost circuit 120 and the output circuit 140; when the system determines that safety failure of the battery module 110 disappears, the second control signal (such as an increased gate voltage signal) is inputted to control the second switch element 130, so that the second switch element 130 is conducted between the boost circuit 120 and the output circuit 140.

According to the embodiments of the present invention, the rapid shutdown system of an energy storage device is integrated into the boost circuit without an additional installation of a DC breaker or a control logic relay, so that the configuration cost can be effectively reduced.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A rapid shutdown system of an energy storage device, comprising:
a battery module having a first end and a second end;
a boost circuit, comprising a first switch element and an active or passive switch element, wherein the first switch element, having one end connected to the active or passive switch element and another end connected to the second end, is controlled by a first control signal to be conducted or non-conducted between the first end and the second end;
a second switch element having a third end and a fourth end, wherein the third end is connected to the active or passive switch element; and
an output circuit having a fifth end and a sixth end, wherein an output voltage exists between the fifth end and the sixth end, the fifth end is connected to the fourth end, the sixth end is connected to the second end, and the second switch element is controlled by a second control signal to be conducted or non-conducted between the boost circuit and the output circuit.

2. The rapid shutdown system according to claim 1, wherein the boost circuit further comprises a boost capacitor and a boost inductor, two ends of the boost capacitor respectively are connected to the first end and the second end, and the two ends of the boost inductor respectively are connected to the first end and the active or passive switch element.

3. The rapid shutdown system according to claim 1, wherein the passive switch element is a diode.

4. The rapid shutdown system according to claim 3, wherein when the first switch element is conducted, the diode is reverse biased to be non-conducted; when the first switch element is non-conducted, the diode is forward biased to be conducted.

5. The rapid shutdown system according to claim 3, wherein the second switch element and the diode form a two-way cutoff switch assembly or an insulated gate bipolar transistor.

6. The rapid shutdown system according to claim 1, wherein the active switch element is a metal-oxide-semiconductor field-effect transistor (MOSFET).

7. The rapid shutdown system according to claim 1, wherein the second switch element and the active switch element form a source to source butting MOSFET switch assembly.

8. The rapid shutdown system according to claim 1, wherein the output circuit comprises an output capacitor and an output resistor, the output capacitor and the output resistor are connected in parallel between the fifth end and the sixth end of the output circuit.

9. A rapid shutdown system of an energy storage device, comprising:
a battery module having a first end and a second end;
a boost circuit, comprising a first switch element and an active or passive switch element, wherein the first switch element, having one end connected to the active or passive switch element and another end connected to the second end, is controlled by a first control signal to be conducted or non-conducted between the first end and the second end;
a second switch element having a third end and a fourth end, wherein the fourth end is connected to the second end; and
an output circuit having a fifth end and a sixth end, wherein an output voltage exists between the fifth end and the sixth end, the fifth end is connected to the fourth end, the sixth end is connected to the second end, and the second switch element is controlled by a second control signal to be conducted or non-conducted between the boost circuit and the output circuit.

10. The rapid shutdown system according to claim 9, wherein the boost circuit further comprises a boost capacitor and a boost inductor, two ends of the boost capacitor respectively are connected to the first end and the second end, and two ends of the boost inductor respectively are connected to the first end and the active or passive switch element.

11. The rapid shutdown system according to claim 9, wherein the passive switch element is a diode.

12. The rapid shutdown system according to claim 11, wherein when the first switch element is conducted, the diode is reverse biased to be non-conducted; when the first switch element is non-conducted, the diode is forward biased to be conducted.

13. The rapid shutdown system according to claim 11, wherein the second switch element and the diode form a two-way cutoff switch assembly or an insulated gate bipolar transistor.

14. The rapid shutdown system according to claim 10, wherein the active switch element is a metal-oxide-semiconductor field-effect transistor (MOSFET).

15. The rapid shutdown system according to claim 9, wherein the first switch element and the second switch element is a metal-oxide-semiconductor field-effect transistor (MOSFET).

16. The rapid shutdown system according to claim 9, wherein the output circuit comprises an output capacitor and an output resistor, and the output capacitor and the output resistor are connected in parallel between the fifth end and the sixth end of the output circuit.

17. A rapid shutdown method used in the rapid shutdown system of an energy storage device according to claim 1, comprising:
inputting a first control signal to control the first switch element to be conducted or non-conducted, wherein when the first switch element is conducted, the active or passive switch element is non-conducted; when the first switch element is non-conducted, the active or passive switch element is conducted; and
inputting a second control signal to control the second switch element, so that the second switch element is conducted or non-conducted between the boost circuit and the output circuit.

18. The rapid shutdown method according to claim 17, wherein the passive switch element is a diode, and the second switch element and the diode form a two-way cutoff switch assembly or an insulated gate bipolar transistor.

19. The rapid shutdown method according to claim 17, wherein the second switch element and the active switch element form a source to source butting MOSFET switch assembly.

20. The rapid shutdown method according to claim 17, wherein the second switch element and the active switch element form a two-way cutoff switch assembly.
